(19) United States
(12) Patent Application Publication
(10) Pub. No.: US 2014/0330614 A1
(43) Pub. Date: Nov. 6, 2014

(54) Validating SAM Schemas Based on Business Functionalities

(71) Applicant: SAP AG, Walldorf (DE)

(72) Inventors: Jens Lemcke, Karlsruhe (DE); Andreas Friesen, Steinfeld (DE); Bernhard Thimmel, Edingen-Neckarhausen (DE); Otfried Von Geisau, Sinsheim (DE); Piergiorgio Bertoli, Civezzano (Trento) (IT); Marco Pistore, Trento (IT)

(73) Assignee: SAP AG, Walldorf (DE)

(21) Appl. No.: 13/887,453

(22) Filed: May 6, 2013

(51) Int. Cl. G06Q 10/06

(52) U.S. Cl. CPC G06Q 10/0633
USPC 705/7.27

(57) ABSTRACT

Methods, systems, and computer-readable storage media for evaluating a validity of an extended status and action management (SAM) schema. In some implementations, actions include receiving the extended SAM schema, the extended SAM schema being stored as a computer-readable document in memory and being an extension of a core SAM schema, receiving one or more business functionalities, at least one business functionality including a plurality of status vectors along a core trace that can be achieved in the core SAM schema, the one or more business functionalities being provided in a computer-readable document stored in memory, and processing the extended SAM schema and the one or more business functionalities using a computer-executable model checking tool for evaluating a validity of the extended SAM schema.

### BACKGROUND

Businesses are increasingly service-driven, where a service can, for example, represent a part of or a complete business process. In some examples, the business process depicts the lifecycle of a business object (BO). A number of actions constrained by a set of business policies can result in the BO transitioning from an initial state to a final state during its lifecycle. Constraints can vary for different customized business processes. The validity of a business process can depend on the ability of a BO to reach an acceptable state.

### SUMMARY

Implementations of the present disclosure include computer-implemented methods for evaluating a validity of an extended status and action management (SAM) schema. In some implementations, actions include receiving the extended SAM schema, the extended SAM schema being stored as a computer-readable document in memory and being an extension of a core SAM schema, receiving one or more business functionalities, at least one business functionality including a plurality of status vectors along a core trace that can be achieved in the core SAM schema, the one or more business functionalities being provided in a computer-readable document stored in memory, and processing the extended SAM schema and the one or more business functionalities using a computer-executable model checking tool for evaluating a validity of the extended SAM schema.

In some implementations, actions further include providing an extended finite state machine (FSM) based on the extended SAM schema, the extended FSM representing states of the extended SAM schema and transitions between states, the extended FSM being provided as a computer-readable document and being stored in memory, wherein processing further comprises processing the extended FSM.

In some implementations, processing the extended SAM schema and the one or more business functionalities includes: generating one or more traces, a trace defining a path of status vectors and actions that are possible through the extended SAM schema, and comparing the one or more traces to the one or more business functionalities to determine whether a respective trace represented by a business functionality is absent from the one or more traces.

In some implementations, processing the extended SAM schema and the one or more business functionalities includes determining that a trace represented by a business functionality is not achievable by the extended SAM schema and, in response, indicating that the trace is not achievable.

In some implementations, processing the extended SAM schema and the one or more business functionalities includes determining that the extended SAM schema does not preserve all core traces of the core SAM schema.

In some implementations, processing the extended SAM schema and the one or more business functionalities includes determining that the extended SAM schema preserves at least one core trace of the core SAM schema and, in response, indicating that at least one core trace is preserved.

In some implementations, a business functionality is defined as a tuple of status vectors and respective values of the status vectors.

In some implementations, processing the extended SAM schema and the one or more business functionalities includes analyzing overlapping traces and indicating absence of a business functionality in the extended SAM schema based on the analyzing.

In some implementations, actions of the core SAM schema are provided as one of nominal actions and non-nominal actions.

In some implementations, processing the extended SAM schema and the one or more business functionalities includes removing non-nominal actions from evaluating validity of the extended SAM schema.

In some implementations, the process includes a business process.

In some implementations, the core SAM schema is determined to be valid.

In some implementations, the extended SAM schema is provided based on a business object (BO) extension that points to a core BO, the BO extension including business object node (BON) extensions, each BON extension pointing to a respective BON of the core BO.

In some implementations, the core SAM schema is provided based on the core BO.

The present disclosure also provides a computer-readable storage medium coupled to one or more processors and having instructions stored thereon which, when executed by the one or more processors, cause the one or more processors to perform operations in accordance with implementations of the methods provided herein.

The present disclosure further provides a system for implementing the methods provided herein. The system includes one or more processors, and a computer-readable storage medium coupled to the one or more processors having instructions stored thereon which, when executed by the one or more processors, cause the one or more processors to perform operations in accordance with implementations of the methods provided herein.

It is appreciated that methods in accordance with the present disclosure can include any combination of the aspects and features described herein. That is, methods in accordance with the present disclosure are not limited to the combinations of aspects and features specifically described herein, but also include any combination of the aspects and features provided.

The details of one or more implementations of the present disclosure are set forth in the accompanying drawings and the description below. Other features and advantages of the present disclosure will be apparent from the description and drawings, and from the claims.

### DESCRIPTION OF DRAWINGS

FIG. 1 depicts an example process in accordance with implementations of the present disclosure.

FIG. 2A depicts an example context within which implementations of the present disclosure can be applied.

FIG. 2B depicts an example object model.

FIG. 3 depicts an example core status and action management (SAM) schema providing constraints on actions that can be executed in the example context of FIG. 2A.

FIG. 4 depicts another example SAM schema including an example extension.

FIG. 5 depicts another example extension to the example SAM schema of FIG. 4.

FIG. 6 depicts another example extension to the example SAM schema of FIG. 4.

FIG. 7 is a schematic illustration of example computer systems that can be used to execute implementations of the present disclosure.

Like reference symbols in the various drawings indicate like elements.

### DETAILED DESCRIPTION

Implementations of the present disclosure are generally directed to providing business functionalities of a business process that is expressed in an extended status and action management (SAM) and validating the extended SAM schema against the business functionalities. More particularly, business functionalities can be modeled as one or more paths for reaching a status vector, or goal. In some examples, each business functionality can represent one or more intermediate status vectors between status vectors. That is, for example, a business functionality can represent a path of status vectors between two status vectors. In some examples, business functionalities are provided as a complex logical expression defining a property of the extended SAM schema. Some business functionalities of a core business process, embodied in a core SAM schema, and of an extended business process, embodied in an extended SAM schema, can be equally valuable. Some business functionalities of a core business process and of an extended business process can have a different value. In some examples, an extension to a SAM schema can modify, or remove a business functionality.

An extended SAM schema can be verified based on a finite state machine (FSM) and one or more business functionalities. The validation of the extended SAM schema can determine whether the extended SAM schema, and thus an underlying extended business process, preserves the core business functionalities. In short, the present disclosure provides a verification process of realizability of business functionalities from the initial status vector associated with the extensions implemented in the extended SAM schema.

In some implementations, a user can select which business functionalities are important and which business functionalities are unnecessary for a particular business process. In an example context, a business functionality can be a feature of a product (e.g., business object) in an advertisement brochure. The product is provided with a set of features (e.g., business functionalities), and the user can decide how to use the product, therefore defining some features as being important. An upgraded model of the product can include some of the previously existing features, some new features and it can miss other features that were previously available. The user, can decide based on the importance of particular features if the upgraded model matches the purpose of the intended use or not and, therefore, decide if the upgraded model is acceptable or not.

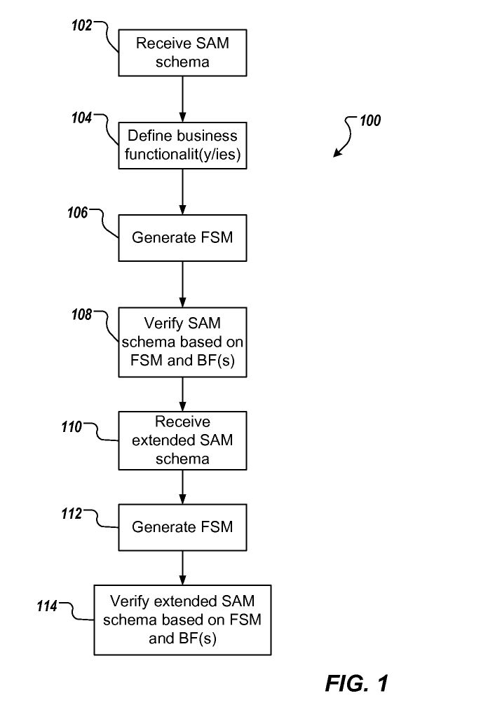

FIG. 1 depicts an example process 100 in accordance with implementations of the present disclosure. In some implementations, the example process 100 can be provided using one or more computer programs that are executed using one or more computing devices.

A SAM schema is received (102). In some examples, the SAM schema can be provided as a computer-readable document that is received from computer-readable memory. For example, the SAM schema can be provided in a machine-readable specification language, discussed in further detail herein. One or more business functionalities of the SAM schema are defined (104). In some examples, the business functionalities represent properties of the SAM schema and can be defined in a machine-readable specification language. A FSM is generated (106). In some examples, the FSM is generated based on the SAM schema and can be provided as a computer program code. The SAM schema is verified based on the FSM and one or more business functionalities (108). In some examples, the FSM and the business functionalities are provided to a computer-executable model checking tool as respective computer-readable documents. An extended SAM schema is received (110). In some examples, the extended SAM schema can be the SAM schema modified by a user. An extended FSM is generated (112). In some examples, the extended FSM is generated based on the extended SAM schema and can be provided as computer program code. The extended SAM schema is verified based on the extended FSM and one or more business functionalities (114). In some examples, the extended FSM and the business functionalities are provided to a computer-executable model checking tool as respective computer-readable documents. The computer-executable model checking tool processes the extended FSM and the business functionalities, as discussed in further detail herein, to determine a validity of the extended SAM schema.

In general, SAM schemas provide a consistent approach to status modeling and implementation activities of data objects (e.g., a business object (BO), or business object node (BON)). More particularly, a SAM schema can be defined at design-time and can be provided as a schema model that is stored in computer-readable medium. The SAM schema includes preconditions for performing actions with each precondition identifying how a status affects whether an action is allowed to be performed at runtime by a data object node instance having the status. A status schema instance is created for a particular object node instance that is used in a computer-based process. The status schema instance corresponds to the status schema model.

In some examples, one or more BOs can be associated with a business process and can be manipulated during execution of the business process. In some examples, manipulation of a BO can result in the BO transitioning from one status to another status. In some examples, a BO is provided as a hierarchical structure of BO nodes (BONs). In some examples, BON can correspond to a header of the BO, and one or more BONs can correspond to respective one or more items that make up the BO. As used herein, reference to a SAM schema of a BO can indicate a SAM schema of a BON (e.g., the SAM schema can refer to a header or an item of a BO, or the BO itself, as applicable).

In some examples, during execution of a business process, a method that changes attribute values of the BO can be executed. Consequently, the BO (e.g., a BON of the BO) can transition from one status to another status. In some examples, a status can be defined as the combination of the current attribute values of a BON at a given point in time. In some examples, a status of the BO can be defined based on the respective statuses of the BONs that make up the BO. In some examples, an attribute of BON can be classified into categories. Example categories can include standard attributes (e.g., a customer name) and status variables.

In some examples, status variables are additional attributes that describe milestones in a lifecycle of the BON. Status variables can provide an aggregated and interpreted view of the status of the BON. In some examples, the status of a BON can be defined based on the values of the status variables at a given point in time. In some examples, the status can be provided as a BO attribute and a modeled entity of SAM that represents the lifecycle of a BON (the result of a processing step). Consequently, a status variable specifies a certain milestone in the lifecycle of a BON (e.g., “order confirmed”). In terms of the business process, this status is indicative of the current status of the business process. Accordingly, a status is a named result of a process step within the business process that is a precondition for a following process step.

During the lifecycle of a BON, the BON can enter various statuses. In order to change a status, an action can be performed on the BON. In some examples, it is not desirable to enable state changes from any status to any other status and/or to enable actions with any status as a precondition for a state change. Consequently, the SAM schema refines a BON model, discussed in further detail below, in terms of a constraint-based model that governs the lifecycle of the BON. In some examples, the SAM schema is intended to define all possible statuses of a BON, possible actions that can be performed on the BON, the resulting statuses, and preconditions in terms of statuses that have to be reached to perform a certain action. In other words, the SAM schema provides a constraint-based model that defines constraints between statuses and actions. Consequently, the SAM schema is a status schema model type. In some examples, a status schema includes the status variables of a BON, the possible status transitions to the values of these status variables (i.e., triggered by actions) and of preconditions that guard changes to the status variables. At design time, for a given BON, various status schemas can be defined and, when the BON is initialized, one of the status schemas is selected and loaded into the runtime. During runtime (e.g., execution of the modeled process), status changes of a BON occur as they are modeled. Consequently, it can be ensured that no changes other than modeled changes occur and required changes actually do occur. In order to do so, the SAM schema (constructed during the design time) is loaded and evaluated at runtime. Accordingly, a SAM schema describes the expected runtime behavior of a BON in a certain business context and represents the relationship between the status of a BON and its actions, and actual variable values provided during runtime can be compared to the SAM schema to ensure the modeled process is executed as expected.

In summary, a status schema can include multiple elements. Example elements include the multi-valued status variables, the actions, and edges that define a relationship between a status value and an action. As discussed above, the status variables and the corresponding values represent the status of a BON, where a status variable contains multiple possible status values. At runtime, every status variable will have exactly one of the possible status values at any given time. The actions represent the methods that can be performed on the BON. For any given action, whether the action is allowed to be performed can depend on the current status of the BON. The edges represent preconditions that connect status values with actions. The preconditions provide that the actions can only be executed if the status variables have certain required values. However, preconditions do not lead to automatic execution of the corresponding actions (i.e., just because a precondition for a particular action is fulfilled, the particular action is not automatically executed). In some examples, if an action that is allowed by the preconditions is called, the action changes the state of the BON and executes exactly one of possibly several status transitions that originate therefrom. In some examples, edges can be provided between one status value of one variable to another status value of another variable, indicating that one status update directly triggers another status update (e.g., synchronizing).

In some implementations, example elements of a status schema can include advanced modeling elements. In some examples, advanced modeling elements can extend simple SAM modeling. By way of non-limiting example, an advanced modeling element can enable creation of a header status by aggregating various item status values.

A FSM can be generated based on the SAM schema. In some implementations, the FSM includes nodes and edges between nodes. In the following, we refer to nodes without incoming edges as root nodes, we refer to nodes without outgoing edges as leaf nodes, and we refer to all other nodes as intermediary nodes. In some examples, a root node of the FSM can represent an initial status (e.g., of a BON) and arbitrary nodes can represent final outcomes of status transitions (e.g., primary goals and/or recovery goals). Nodes on a trace between an initial status and a goal that are neither initial status nor goal can each represent an intermediate status (e.g., of the BON) between the initial status and the goals. Edges between nodes can represent actions that can be performed to transition from one status to another status.

Implementations of the present disclosure are discussed in further detail herein with reference to example contexts. The example contexts include a service-based business processes (e.g., invoice processing, materials inspection). It is appreciated, however, that implementations of the present disclosure are applicable to other contexts.

In the evolving world of service-based business processes, there is an increasing demand on customizability and reliability. A service can be perceived as a part of or a complete business process. A service can be composed of a series of atomic actions that perform small tasks. The actions can move a BO from one state, or status, to another status. In some examples, the BO can be an electronic document representing a product in supply-chain management or an item of sale in an online store. In some examples, status changes can occur by executing an action during the business process. A number of possible goals in such business processes can be defined by some final states (e.g., product shipped, order cancelled). Executability of the actions and firing of the events are constrained or guided by strict business rules, which can vary for different customers.

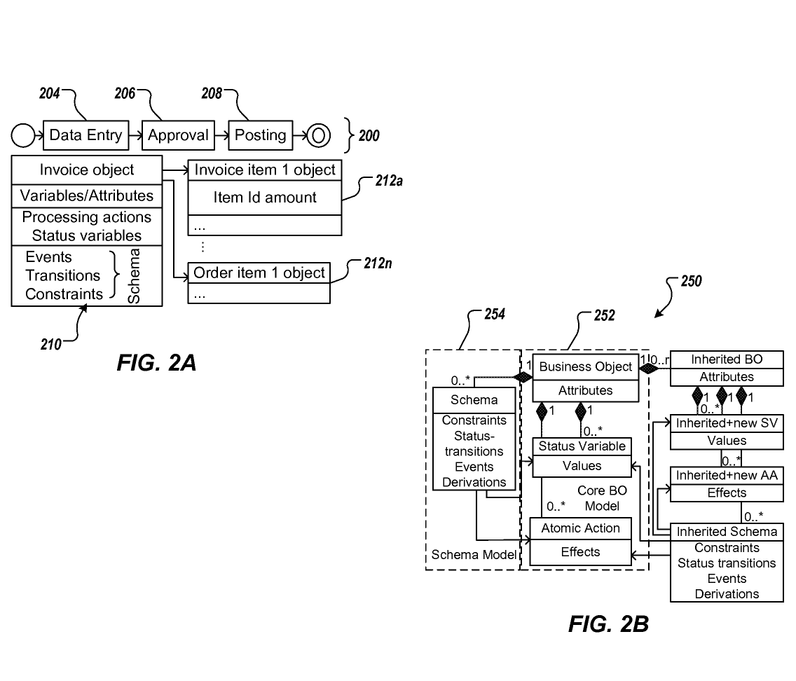

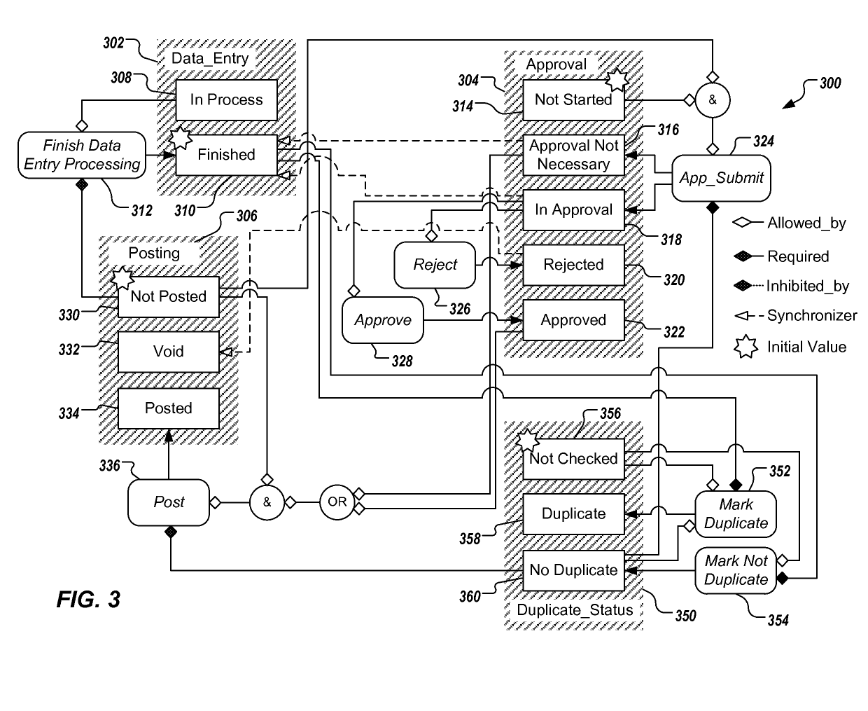

FIG. 2A depicts an example context within which implementations of the present disclosure can be applied. The example context includes a service-based business process, an invoicing process 200, in particular. The example invoicing process 200 includes a data entry sub-process 204, an approval sub-process 206 and a posting sub-process 208. In the examples context, an invoice object 210 (i.e., invoice BO) is provided and is linked to multiple invoice objects 212a-212n. Actions are provided and are controlled by business constraints, as discussed in further detail below with reference to FIG. 3. Each action can move the invoice object 210 through the data entry sub-process 204, the approval sub-process 206 and the posting sub-process 208.

At any point in the invoicing process 200, the status of a BO is defined by a set of status variables. In the example context, an example status variable can be provided as Data_Entry. Potential values of the Data_Entry status variable within the data entry sub-process 204 can include “finished” and “in process.” An example action that can cause the invoice BO to move from one status to another during the data entry sub-process 204 can include “finish data entry processing.” In some examples, the data entry sub-process 204 can be projected as an invoicing service. Consequently, the actions provided within the data entry sub-process 204 can define the lifecycle of the invoice BO. To ensure reliability of such business processes, the constraints can be validated, as discussed herein, so that the invoice BO moves through the correct execution statuses and ends up in one of the primary goal or recovery goal statuses.

FIG. 2B depicts an example object model 250. The example object model 250 is provided as a BO model that includes a core BO model 252 and a constraint-driven lifecycle model referred to as the SAM schema model 254. In some examples, the core BO model 252 describes static features or components associated with the BO, and the SAM schema model 254 describes the dynamics, or lifecycle, of the BO. The multi-part modeling of the present disclosure enables the added flexibility of attaching different SAM schema models to the same BO model for the different business cases. Further, the BO and the schema can be extended as needed without affecting the core BOs. The constraints are defined based on execution statuses, where status transitions are caused by actions and events.

As discussed in detail above, a BO can include attributes or variables. The attributes are initialized at the time of instantiation of the BO and can assume different values during the business process that acts on the BO. In the example of FIG. 2A, the invoice BO 210 in the invoicing process 200 can include attributes such as Order ID, number of order items, and amount. As also discussed above, a BO is associated with a number of status variables (SV), each SV representing the status of the BO during a sub-process of the lifecycle of the BO and having a set of values associated therewith, including an initial value. In the example context, the Data_Entry SV can assume one of the values “finished” and “in process.” The status variables of a BO together represent the combined status or state of the BO. During the business process, actions are performed that cause status transitions. In the example object model 250 of FIG. 2B, actions can be referenced as atomic actions (AA). In the example context, the “finish data entry processing” action moves the BO from the “in process” status to the “finished” status.

In some examples, a SV can be affected by several AAs, while an AA only affects a single SV or no SV at all. In some examples, the effect of an AA on a SV can be deterministic or non-deterministic (i.e., the AA sets the SV always to a specific value, or to one of several possible values depending on some user input or attributes of the BO). In the example context, the “modify” action can display options and, based on user input selecting an option, moves the BO non-deterministically to either the “saved” status or the “submitted” status.

Status transitions are caused by actions, events, and/or derivations. In some examples, an event is fired when a SV has a certain value, and causes a specific status transition that can be used to synchronize the values of different SVs. For example, a “in approval” status value of an Approval SV, discussed in further detail below, causes an event to synchronize the value of the Data_Entry SV to “finished.”

In some examples, a derivation is provided as a means to dynamically determine status information from multiple SVs. A derivation also enables distribution of the status information of a parent BON to multiple descendent BONs and vice versa and modeling dependencies among BONs. For example, and with reference to FIG. 2A, if an invoice is rejected, a status can be set to “void.”

The BO model of the present disclosure provides a strong foundation for designing flexible and customizable business processes to meet varying consumer requirements. The BO model further provides a general framework that can be extended for different types of BOs.

FIG. 3 depicts an example SAM schema 300 providing constraints on actions that can be executed in the example context of FIG. 2A. More particularly, FIG. 3 depicts a Data_Entry SV 302, an approval SV 304 and a Posting SV 306. Example values for the Data_Entry SV 302 include “in process” 308 and “finished” 310. An example action that can be executed to transition the Data_Entry SV 302 between values includes “finish data entry processing” 312. Example values for the Approval SV 304 include “not started” 314, “approval not necessary” 316, “in approval” 318, “rejected” 320 and “approved” 322. Example actions that can be executed to transition the Approval SV 304 between values include “app_submit” 324 (submit for approval), “reject” 326 and “approve” 328. Example values for the Posting SV 306 include “not posted” 330, “void” 332 and “posted” 334. An example action that can be executed to transition the Posting SV 306 between values includes “post” 336.

FIG. 3 provides a graphical representation of constraint types that can be defined in the example BO model (e.g., of FIG. 2B). In the depicted example, an action is enabled if any one of the “Allowed_by” and all of the “Required” conditions (constraints) are true, and all of the “Inhibited_by” conditions (constraints) are false. Each of these conditions can be more complex if, for example, values of multiple SVs are joined using logical operators (e.g., AND, OR). In the example constraints of FIG. 3, “post” 336, which affects the value of the Posting SV 306, is executable when the Approval SV 304 has the value of either “approval not necessary” 316 OR “approved” 322 AND (&) the Posting SV 304 has the value “not posted” 330 (i.e., the invoice has not been posted).

In some implementations, the BO model depicts a SAM model and can be defined using a machine-readable specification language. An example specification language can be denoted by the acronym SAMLA (e.g., SAM LAnguage). In the example context, an example specification can be provided as:

```
BON BusinessObj {
  STATUS_VARS Data_Entry, Approval, Posting
  VARIABLE Data_Entry
    VALUES finished, in_process
    INITIAL in_process
  VARIABLE Approval
    VALUES not_started, approval_not_necessary, in_approval, rejected,
    approved
    INITIAL not_started
  VARIABLE Posting
    VALUES not_posted, void, posted
    INITIAL not_posted
  ACTIONS ACT_Finish_Data_Entry_Processing, ACT_App_Submit,
    ACT_Reject, ACT_Approve, ACT_Post
  SCHEMAS Schema1
}
```

where a BON represents a BO model. Generally, and as depicted in the example above, a BON specification defines the list of SVs, the set of values for each SV including the initial value, the AAs, and schemas associated with the BO. In some implementations, an example schema model can be provided as:

SCHEMA Schema1 {
ACTION ACT_Finish_Data_Entry_Processing

| | |
|---|---|
| ALLOWED_BY | Data_Entry = in_process |
| REQUIRED | Posting = not_posted |

ACTION ACT_App_Submit

| | |
|---|---|
| ALLOWED_BY | Approval = not_started & |
| | Posting = not_posted |

ACTION ACT_Reject

| | |
|---|---|
| ALLOWED_BY | Approval = in_approval |

ACTION ACT_Approve

| | |
|---|---|
| ALLOWED_BY | Approval = in_approval |
| ACTION ACT_Post | |
| ALLOWED_BY | (Approval = approval_not_necessary |
| | OR approved) AND |
| | Posting = not_posted |

```
  . . .
  SYNCHRONIZE Approval = approval_not_necessary OR in_approval
```

TO Data_Entry = finished

. . .
}

In general, and as depicted in the above example, a schema specification defines the constraints on each AA, the state transitions caused by each AAs (i.e., the possible values of the associated SV if the action is performed), and events such as status synchronizers.

Multiple types of constraints can be defined for each AA. In some examples, an action is executable if any one of the ALLOWED_BY constraints is true (i.e., multiple constraints joined by logical OR operations), all REQUIRED constraints are true (i.e., multiple constraints joined by logical AND operation), and none of the INHIBITED_BY constraints is true (i.e., each condition is negated and then joined by logical AND). In some examples, the CAUSES part of an ACTION specification in the schema indicates the effect of the action. In some examples, CAUSES having two or more parts indicates that the result of the AA is non-deterministic (e.g., the modify action in the example schema model above). In some examples, SYNCHRONIZE denotes an event that sets a second SV to the specified value when a first SV is assigned a certain value.

The core SAM schema 300 of FIG. 3 further includes a Duplicate_Status SV 350 and the actions “mark duplicate” 352 and “mark not duplicate” 354. Example values for the Duplicate_Status SV 350 include “not checked” 356, “duplicate” 358 and “no duplicate” 360. In the depicted example, constraints include that the Data_Entry SV 302 must have the value of “finished” 310 before the actions “mark duplicate” 352 and “mark not duplicate” 354 can be performed. Further, the action “reject” 326 is disabled.

Implementations of the present disclosure address extensibility of a core SAM schema to provide an extended SAM schema. In some implementations, requirements for model (SAM schema) extension can include that an extension should not modify the model (because only then extensions and model changes are reconcilable); two extensions should not conflict with each other; extensions should be extensible as well; and extensions should only influence the model in such a way, that the functionality of the BO using the model is not be harmed.

In some implementations, a SAM extension adds additional actions to the BON, as well as status variables and an additional model snippet containing the SAM model for the extension. In some examples, the added elements are modeled in a BO extension that points to a BO and that extends the BO. In some examples, the BO extension includes BON extensions, each of which points to a respective BON of the BO. In some examples, the BON extensions have the same names as the BONs that they point to, but the namespaces can be different. In some examples, a BON extension carries the additional (enhanced) actions and (enhanced) status variables (SVs) that are defined as part of the BON extension. Furthermore the BON extension carries a status schema extension pointing to a status schema. In some examples, a status schema extension has the same name as the status schema that it points to, but includes a different namespace.

In some implementations, the extensibility of SAM schemas follows rules that ensure that the resulting model does not harm the functionality of the underlying BO. In some examples, the following modeling elements are allowed in a SAM schema extension: status variables, actions, preconditions, status transitions (including actions with multiple status transitions), synchronizers, stateguards and overall derivation. In some examples, the following rules describe which modeling elements are allowed/not allowed between the extension and the underlying (core) SAM schema and the SAM schema extension:

Underlying (core) SAM schema→Extension:
Allowed=preconditions and synchronizers
Not Allowed=status transitions or derivation edges

Extension→Underlying (core) SAM schema:
Allowed=inhibiting preconditions and requiring preconditions
Not Allowed=status transitions, enabling preconditions, derivation edges, synchronizers, or neutral preconditions

Further rules can include that a SAM schema extension should not add, change or remove edges that are neither connected to an extension status nor to an extension action. For example, the following are not allowed: adding or deleting preconditions within the core SAM schema adding or deleting status transitions within the core SAM schema. In some examples, an extension should not lead to a deadlock. That is, an extension should, at most, only delay when an action of the core SAM schema can be executed, but should not forbid the action. In some examples, an extension can lead to a deadlock. For example, deadlocks can be allowed for traces that would result in recovery goals in the core SAM schema. In some examples, synchronizers to extensions can originate from any status value of the core SAM schema except values of a derived status variable or values other than the initial value that can be set by a state guard. In some examples, no additional flag indicating when a status value can be used as the origin of a synchronizer can be provided.

In general, the example rules discussed above are provided to avoid influencing the behavior of the underlying BO in an illegal way. The rules ensure that the state and the status of a BO are always in synchronization with one another. Further, shortcuts are not achievable using an extension. Accordingly, a status transition from an extension action to a status value of the underlying BO (core status value) is not allowed, because it would then be possible to set a core status value without having the corresponding state of the BO (i.e., the state and the status would be out of synchronization with one another, which is not allowed). The state of the core BO can only be maintained by executing core actions. For this reason, shortcuts (e.g., bypassing a core action) by means of the extension are also not allowed. The integrity of the core BO is only maintained if no core action is bypassed. If a core action were bypassed, new states would be possible in the core, which would not be able to be processed. Further, a bypassed core action would not able to transform the state of the BO corresponding to the status change. Consequently, no modeling elements are allowed that would lead to set a core status or to bypass a core action.

In accordance with implementations of the present disclosure, a SAM schema extension that is applied to a core SAM schema (providing an extended SAM schema) can be validated using one or more business functionalities that are declared for the core SAM schema. In some examples, the main condition for extension validity is that one or more particular status vectors or actions can be reached. However, in some cases, a particular status vector or action can be reached using one of a plurality of traces (status vector paths). In some examples, an extension can result in the removal of a path. Although the particular status vector or action can still be reached, it could be important to the underlying business requirements that the status vector or action be reachable using the removed path. Consequently, business functionalities can be provided, where each business functionality represents a trace or portion of a trace, such that removal of a trace or portion of a trace in an extended SAM schema can trigger invalidity of the extended SAM schema, as discussed in further detail herein.

As introduced above, business functionalities can be modeled as one or more paths for reaching a status vector, or goal, where each business functionality can represent one or more intermediate status vectors between status vectors (e.g., a path of status vectors between two status vectors). In some examples, business functionalities are provided as a complex logical expression defining a property of the extended SAM schema. In some examples, business functionalities do not include an indication of importance. Instead, at the implementation time of the core SAM schema, all implemented features of the business object can be considered equally valuable. At the implementation time of the extended SAM schema, some business functionalities of the core SAM schema can be valuated. For example, all business functionalities of the implemented extension are again equally important, but an actual importance can be assigned to business functionalities during deployment in an enterprise scenario. That is, an enterprise implementing the extension can determine which business functionalities are important and which are unnecessary for their specific business needs.

Implementations of the present disclosure are described in further detail below with reference to an example SAM schema and example extensions. It is contemplated, however, that implementations of the present disclosure are also applicable to other SAM schemas and other extensions.

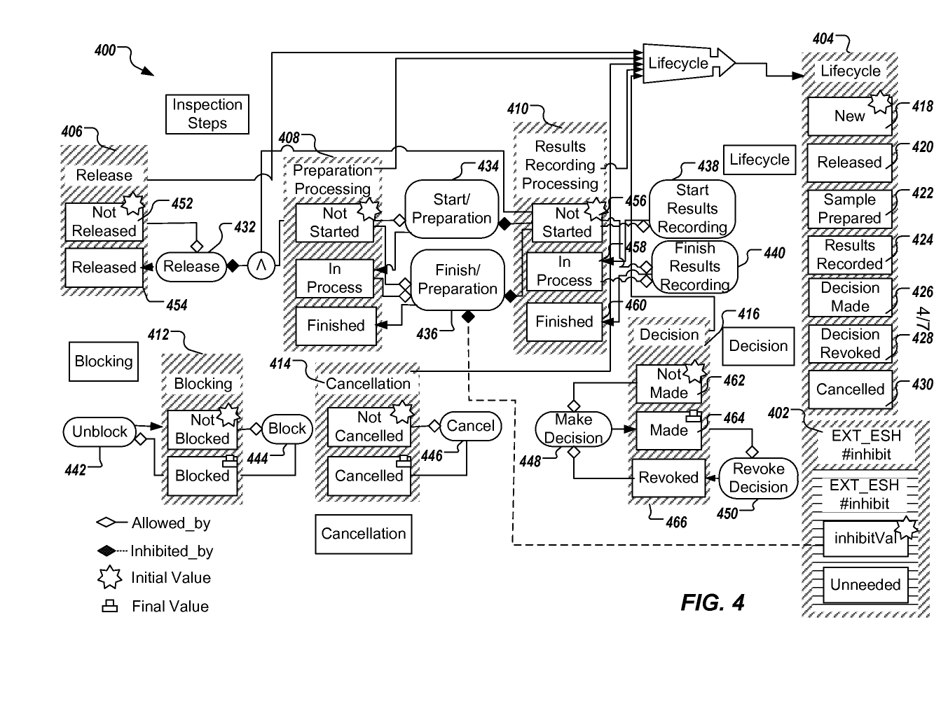

FIG. 4 depicts another example SAM schema 400 including an example extension EXT_ESH 402. In particular, the example SAM schema 400 provides a schema for a Material Inspection Sample (MIS) business object. The example SAM schema 400 further includes a Lifecycle SV 404, a Release SV 406, a Preparation Processing SV 408, a Results Recording Processing SV 410, a Blocking SV 412, a Cancellation SV 414 and a Decision SV 416. Example values for the Lifecycle SV 404 include “new” 418, “release” 420, “sample prepared” 422, “results recorded” 424, “decision made” 426, “decision revoked” 428 and “cancelled” 430. The example SAM schema 400 further includes a plurality of actions (e.g., “release” 432, “start preparation” 434, “finish preparation” 436, “start results recording” 438, “finish results recording” 440, “unblock”442, “block” 444, “cancel” 446, “make decision” 448 and “revoke decision” 450). An example action that can be executed to transition the Release SV 406 between values (e.g., “not released” 452 and “released” 454) includes the action “release” 432. Some actions can simultaneously determine the value of multiple status variables. For example, the action “start preparation” 434 initiates the transition between values of the Preparation Processing SV 408 and of the Results Recording Processing SV 410.

In the context of the illustrated example, the BO provides a sample for examination during a material inspection. Value “new” 418 can correspond to the inbound delivery of a material for physical and chemical inspection in a laboratory, for example. Specifications of the sample's quality can be stored in the data fields of the business object, activating the “results recorded” 424 value. The decision values (“decision made” 426 and “decision revoked” 428) indicate whether the sample can be further used in the material inspection.

The business process defined by the MIS can include one or more steps (e.g., creation of a sample, preparation of inspection, documentation of inspection results, and documentation of the inspection decision). In some examples, a sample can be released (e.g., Release SV 406 can have the “release” 454 value) for further steps. The steps include preparing the sample for inspection (e.g., Preparation Processing SV 408) and recording results or deviations (e.g., Results Recording Processing SV 410). In some examples, a decision (e.g., Decision SV 416) can be made immediately or at any time after sample creation. In some examples, the Decision SV 416 closes the business process of MIS. In some examples, one or more actions are available for a user's selection only after other actions were completed. For example, the action “start preparation” 434 can be automatically made visible after the action “release” 432 was selected by a user. In some examples, one or more actions can be automatically activated after other actions were completed, without requiring a user's selection. For example, the action “start results recording” can be automatically activated without being called, neither internally nor presented as a an option for a user selection. In some examples, one or more actions can modify the steps of the lifecycle. For example, MIS processing can be blocked and unblocked, cancelled, and the decision can be revoked using the corresponding action (e.g., “unblock”442, “block” 444, “cancel” 446, “make decision” 448 and “revoke decision” 450).

The example SAM schema 400 models the sequential execution of the actions “release” 432, “finish preparation” 436, “start results recording” 438, “finish results recording”440, and “make decision” 448. In some examples, any actions in the sequence before “make decision” 448 can be skipped. In some examples, some action sequences can be shortcuts of other action sequences, leading to the same action without containing all previous actions.

An extension of the SAM schema 400 can be attached to a business functionality to modify the steps of the lifecycle. The extension EXT_ESH 402, illustrated in FIG. 4, disables the “finish preparation” 436 action. In the illustrated example, the extension EXT_ESH 402 inhibits a business functionality (e.g., Preparation Processing SV 408) from being realized from the initial status vector. In some examples, an extension can forbid a particular action sequence and enforce an action sequence shortcut. For example, the extension EXT_ESH 402 preserves the action “release” 432, which is included in the core path of the action sequences. The extension EXT_ESH 402 also preserves the realizability of a plurality of actions that are not included in the core path of the action sequences (e.g., “start results recording” 438, “finish results recording” 440, “cancel” 446, “make decision” 448 and “revoke decision” 450).

In some implementations, the SAM schema 400 including an extension can be used by a user to determine whether the BO fulfills its requirements of reaching a particular status vector. In some examples, the user can agree with the effect of the extension (e.g., EXT_ESH 402 cancels the preparation of a sample). In some examples, the user can decide that the cancelled action (e.g., Preparation Process SV 408) is mandatory for the business process and thus determine that the extension (e.g., EXT_ESH 402) is unsuitable.

Example business functionalities can be provided for the SAM schema 400. Preservation of the example business functionalities can be assessed in view of modifications (extensions), as discussed in further detail herein. The example business functionalities provided herein are inspired by the values of the lifecycle variable, and are defined using the following status vectors provided in the following example order: (Release, Preparation Processing, Results Recording Processing, Decision, Cancellation). In some examples, logical operators can be used such as a logical NOT (“!”). For example, “! Finished” indicates any possible value except “Finished” (as opposed to a label of “Not Finished,” meaning the concrete value “Not Finished”). In view of this, the following example business functionalities are provided:

Release: (Released, ! Finished, ! Finished, Not Made, Not Canceled)

Prepare Sample: (*, Finished, ! Finished, Not Made, Not Canceled)

Record Results: (*, *, Finished, Not Made, Not Canceled)

Make Decision: (*, *, *, Made, Not Canceled)

Revoke Decision: (*, *, *, Revoked, Not Canceled)

Cancel: (*, *, *, *, Canceled)

The example extension provided in FIG. 4 can be assessed based on the core traces that touch business functionalities and that change as a result of the extension. In the example of FIG. 4, and as noted above, the purpose of the extension is to disable the finish preparation action. That results in forbidding the regular action sequence, but enforcing one of the shortcuts.

In some examples, the effects of the extension on the business functionalities can be provided in different categories ordered by increasing severity. Example categories can include whether the extension preserves all core paths (1), a list of business functionalities where all core paths are preserved (2), a list of business functionalities that preserve realizability at all times, but lack core paths (3), a list of business functionalities that preserve realizability from an initial status vector, but not at all times (4), and a list of business functionalities that preserve realizability from the initial status vector (5). In view of these categories, the example extension of FIG. 4, and the example business functionalities provide the following example category population:

(1) No.

(2) Release.

(3) Record Results, Make Decision, Revoke Decision, Cancel.

(4) None.

(5) Prepare Sample.

This example listing shows that Prepare Sample is not possible with the extension, which is as expected, and shows that, through the extension, almost all other business functionalities are affected, because those paths are pruned that contain prepare sample and lead to the respective status vector.

The analysis can be used by the extender (the person/entity extending the SAM schema) for finding undesired effects of the extension. Additionally, a customer can use the analysis to determine whether the business object fulfills their requirements. The assessment bases on the customer-dependent valuation of the individual business functionalities. For example, the customer might require that preparing a sample is not possible any more, or may decide that preparing a sample is mandatory for their business process and thus the extension is unsuitable.

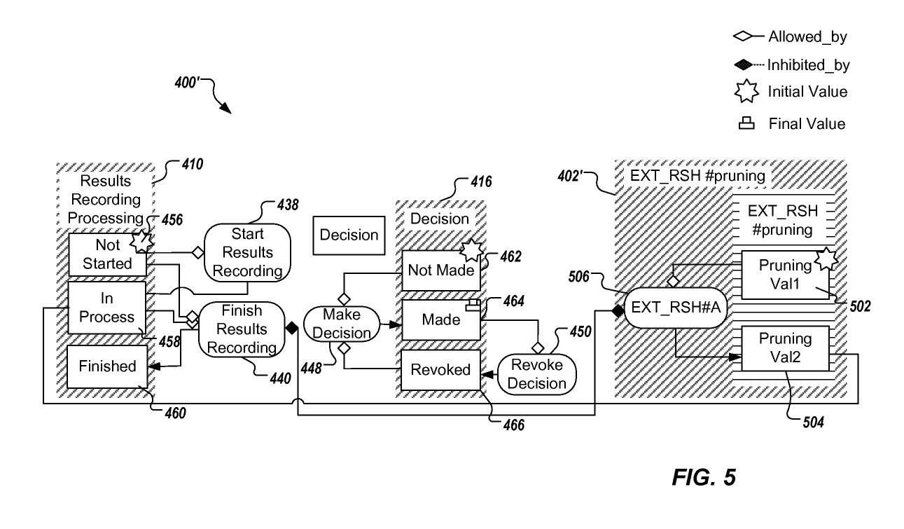

As discussed above in view of the example of FIG. 4, many business functionalities can be reported to lack core paths, although only one interesting change was made (i.e., inhibiting Prepare Sample). In this example, the other effects are implicit, which may be tolerated as indeed, a main action is missing in the core paths of many business functionalities. However, the same problem can cause more severe misclassification, as discussed below with reference to FIG. 5. In the examples of FIG. 5, the core SAM schema is a reduced version of that in FIG. 4 with a different extension to concentrate on a false positive problem.

FIG. 5 depicts another example extension, provided as EXT_RSH extension 402′, to an example reduced SAM schema 400 of FIG. 4. The example reduced SAM schema 400 includes the Results Recording Processing SV 410 and the Decision SV 416. Example values for the EXT_RSH extension 402′ include “pruning value 1” 502 and “pruning value 2” 504. The example SAM schema 400 further includes a plurality of actions (e.g., “start results recording” 438, “finish results recording” 440, “make decision” 448, “revoke decision” 450 and “extension action” 506).

In the context example of FIG. 5, some actions of the core path cannot be performed, creating a false positive problem. For example, some actions can only be executed in a particular order, which can be interrupted by other actions. The “extension action” 506 is executed before “finish results recording” 440, which is invoked to transition the Results Recording Processing SV 410 between values (e.g., “in process” 458 to “finished” 460). Some actions can be executed at an arbitrary time. For example, “make decision” 448 can be invoked at any time.

The extended SAM schema 400 can be validated to determine whether the core business functionalities are preserved. In the context example of FIG. 5, the verification process indicates that the example EXT_RSH extension 402′ affects the example SAM schema 400 in such a way that the core path is not preserved.

In the example context, even if the core path is not preserved, some business functionalities preserve realizability at all times creating a false positive problem. For example, “start results recording” 438, “make decision” 448 and “revoke decision” 450 preserve realizability at all times. A report of the validation of the extended SAM schema 400 can include the problem with Results Recording Processing SV 410 and the associated actions, “start results recording” 438 and “finish results recording” 440. The report of the validation of the example SAM schema 400 can include a list of the business functionalities that are not affected by the extension (e.g., “make decision” 448 and “revoke decision” 450). Accordingly, and in view of the categories defined above, the example extension of FIG. 5 and the example business functionalities provide the following example category population:

(1) No.

(2) None.

(3) Record Results, Make Decision, Revoke Decision.

(4) None.

(5) None.

In this example, the false positive results, because a problem with Make Decision and Revoke Decision should not be reported.

In some implementations, a false positive problem introduced by an extension can be mitigated by analyzing the overlapping paths and reporting the effects of the directly affected business functionality. In the solution to the false positives problem, the reporting of follow-on errors can be eliminated by covering all status vectors of business functionalities or loops, which exist in the transition system. If a business functionality covers multiple phases of the business process, a reported problem may refer to any of those phases.

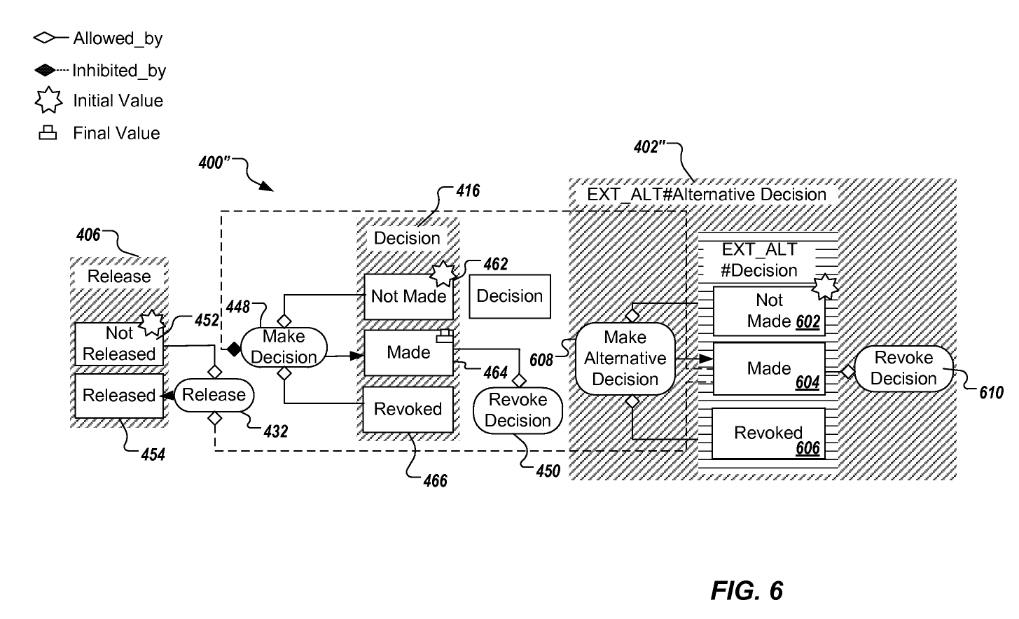

In some cases, false negatives can be reported using the business functionalities approach of the present disclosure. An example false negative is discussed herein with reference to FIG. 6 below, which provides the SAM schema of the MIS business object cropped to the release and decision actions.

FIG. 6 depicts another example alternative decision extension 402″ to an example reduced SAM schema 400 of FIG. 4. The example reduced SAM schema 400 includes a Release SV 406 and a Decision SV 416. Example values for the alternative decision extension 402″ include “not made” 602, “made” 604 and “revoked” 606. The example SAM schema 400 further includes a plurality of actions (e.g., “release” 432, “make decision” 448, “revoke decision” 450, “make alternative decision” 608 and “revoke decision” 610). The purpose of the extension is to implement an alternative way of documenting a decision, where the decision can exclusively either be taken in the core or in the extension, and both decisions can be revoked and redone.

In the context example of FIG. 6, some actions can be performed in multiple locations creating a false negative problem. For example, the make decision action can be performed in the core path (e.g., “make decision” 448) or in the extension (e.g., “make alternative decision” 608). In some implementations, an action can be revoked or modified, independent of the location where it was performed. For example, the make decision action (e.g., “make decision” 448 performed in the core path or “make alternative decision” 608 performed in the extension) can be revoked and redone.

The extended SAM schema 400 can be validated against example business functionalities defined above to determine whether the business functionalities are preserved. In the context example of FIG. 6, the verification process indicates that the alternative decision extension 402″ can be performed even after the alternative decision extension 402″ was used. For example, the core action “make decision” 448 can be performed after release even if the action “make alternative decision” 608 has been performed and revoked by the action “revoke decision” 610.

In some implementations, the action “make decision” 448 of the core path can be modified by the action “make alternative decision” 608 in the extension. Making a decision using the alternative decision extension 402″ can transform the BO of the core path where the BO is expected to stay forever to a different status. In some implementations, revoking a decision is an exceptional action.

Accordingly, the analysis performed in view of the categories defined above, the example extension of FIG. 6 and the example business functionalities provides that the extension preserves all core paths. Thus, it seems from the analysis that the extension has no impact on the core. That is technically correct, because the core decision can be taken after release, even if the alternative decision has been taken. This is possible, because the alternative decision can be revoked, which re-enables the core decision. However, taking a decision is a main feature of the core SAM schema from the business perspective. In some circumstances, the decision of the core SAM schema can be neglected by taking a decision in the extension. In contrast to the technical analysis, the impact of the extension on the core SAM schema is actually quite large from the business perspective.

In some implementations, the verification process includes the distinction between nominal and non-nominal actions. A nominal action can be defined as a major action of a schema that is expected to be performed in the regular flow of the business process. A non-nominal action allows deviations from the regular flow. The non-nominal actions are removed from the schema for the validation analysis. In the context example of FIG. 6, the action “revoke decision” 610 and the action “make alternative decision” 608 are defined as non-nominal actions, which makes the analysis result comply with the business perspective. Based on the identification of no-nominal actions, the validation report identifies that the alternative decision extension 402″ does not preserve all core paths.

In some implementations, the solution to the false negatives problem can be related to the fact that final status vectors are not specified. In some implementations, the solution to the false negatives problem can be related to the difference between important and unimportant actions. In some implementations, the solution to the false negatives problem can include a mixture between a primary and recovery goals approach, and the business functionalities approach of the present disclosure.

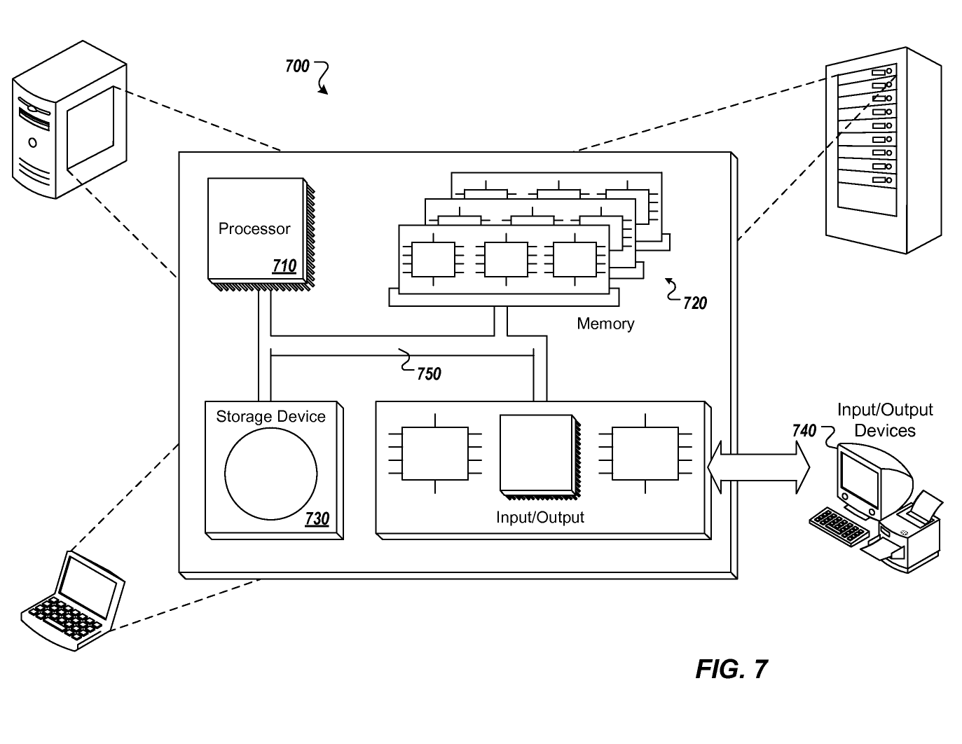

Referring now to FIG. 7, a schematic diagram of an example computing system 700 is provided. The system 700 can be used for the operations described in association with the implementations described herein. For example, the system 700 may be included in any or all of the server components discussed herein. The system 700 includes a processor 710, a memory 720, a storage device 730, and an input/output device 740. The components 710, 720, 730, 740 are interconnected using a system bus 750. The processor 710 is capable of processing instructions for execution within the system 700. In one implementation, the processor 710 is a single-threaded processor. In another implementation, the processor 710 is a multi-threaded processor. The processor 710 is capable of processing instructions stored in the memory 720 or on the storage device 730 to display graphical information for a user interface on the input/output device 740.

The memory 720 stores information within the system 700. In one implementation, the memory 720 is a computer-readable medium. In one implementation, the memory 720 is a volatile memory unit. In another implementation, the memory 720 is a non-volatile memory unit. The storage device 730 is capable of providing mass storage for the system 700. In one implementation, the storage device 730 is a computer-readable medium. In various different implementations, the storage device 730 may be a floppy disk device, a hard disk device, an optical disk device, or a tape device. The input/output device 740 provides input/output operations for the system 700. In one implementation, the input/output device 740 includes a keyboard and/or pointing device. In another implementation, the input/output device 740 includes a display unit for displaying graphical user interfaces.

The features described can be implemented in digital electronic circuitry, or in computer hardware, firmware, software, or in combinations of them. The apparatus can be implemented in a computer program product tangibly embodied in an information carrier, e.g., in a machine-readable storage device, for execution by a programmable processor; and method steps can be performed by a programmable processor executing a program of instructions to perform functions of the described implementations by operating on input data and generating output. The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. Elements of a computer can include a processor for executing instructions and one or more memories for storing instructions and data. Generally, a computer can also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a CRT (cathode ray tube) or LCD (liquid crystal display) monitor for displaying information to the user and a keyboard and a pointing device such as a mouse or a trackball by which the user can provide input to the computer.

The features can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, e.g., a LAN, a WAN, and the computers and networks forming the Internet.

The computer system can include clients and servers. A client and server are generally remote from each other and typically interact through a network, such as the described one. The relationship of client and server arises by virtue of computer programs running on the respective computers and having a client-server relationship to each other.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

A number of implementations of the present disclosure have been described. Nevertheless, it will be understood that various modifications may be made without departing from the spirit and scope of the present disclosure. Accordingly, other implementations are within the scope of the following claims.

What is claimed is:

1. A computer-implemented method for evaluating a validity of an extended status and action management (SAM) schema, the method being executed using one or more processors and comprising:
receiving the extended SAM schema, the extended SAM schema being stored as a computer-readable document in memory and being an extension of a core SAM schema;
receiving one or more business functionalities, at least one business functionality comprising a plurality of status vectors along a core trace that can be achieved in the core SAM schema, the one or more business functionalities being provided in a computer-readable document stored in memory; and
processing the extended SAM schema and the one or more business functionalities using a computer-executable model checking tool for evaluating a validity of the extended SAM schema.

2. The method of claim 1, further comprising providing an extended finite state machine (FSM) based on the extended SAM schema, the extended FSM representing states of the extended SAM schema and transitions between states, the extended FSM being provided as a computer-readable document and being stored in memory, wherein processing further comprises processing the extended FSM.

3. The method of claim 1, wherein processing the extended SAM schema and the one or more business functionalities comprises:
generating one or more traces, a trace defining a path of status vectors and actions that are possible through the extended SAM schema; and
comparing the one or more traces to the one or more business functionalities to determine whether a respective trace represented by a business functionality is absent from the one or more traces.

4. The method of claim 1, wherein processing the extended SAM schema and the one or more business functionalities comprises determining that a trace represented by a business functionality is not achievable by the extended SAM schema and, in response, indicating that the trace is not achievable.

5. The method of claim 1, wherein processing the extended SAM schema and the one or more business functionalities comprises determining that the extended SAM schema does not preserve all core traces of the core SAM schema.

6. The method of claim 1, wherein processing the extended SAM schema and the one or more business functionalities comprises determining that the extended SAM schema preserves at least one core trace of the core SAM schema and, in response, indicating that at least one core trace is preserved.

7. The method of claim 1, wherein a business functionality is defined as a tuple of status vectors and respective values of the status vectors.

8. The method of claim 1, wherein processing the extended SAM schema and the one or more business functionalities comprises analyzing overlapping traces and indicating absence of a business functionality in the extended SAM schema based on the analyzing.

9. The method of claim 1, wherein actions of the core SAM schema are provided as one of nominal actions and non-nominal actions.

10. The method of claim 9, wherein processing the extended SAM schema and the one or more business functionalities comprises removing non-nominal actions from evaluating validity of the extended SAM schema.

11. The method of claim 1, wherein the process comprises a business process.

12. The method of claim 1, wherein the core SAM schema is determined to be valid.

13. The method of claim 1, wherein the extended SAM schema is provided based on a business object (BO) extension that points to a core BO, the BO extension comprising business object node (BON) extensions, each BON extension pointing to a respective BON of the core BO.

14. The method of claim 1, wherein the core SAM schema is provided based on the core BO.

15. A non-transitory computer-readable storage medium coupled to one or more processors and having instructions stored thereon which, when executed by the one or more processors, cause the one or more processors to perform operations for evaluating a validity of an extended status and action management (SAM) schema, the operations comprising:
receiving the extended SAM schema, the extended SAM schema being stored as a computer-readable document in memory and being an extension of a core SAM schema;
receiving one or more business functionalities, at least one business functionality comprising a plurality of status vectors along a core trace that can be achieved in the core SAM schema, the one or more business functionalities being provided in a computer-readable document stored in memory; and
processing the extended SAM schema and the one or more business functionalities using a computer-executable model checking tool for evaluating a validity of the extended SAM schema.

16. A system, comprising:
a computing device; and
a computer-readable storage device coupled to the computing device and having instructions stored thereon which, when executed by the computing device, cause the computing device to perform operations for evaluating a validity of an extended status and action management (SAM) schema, the operations comprising:
receiving the extended SAM schema, the extended SAM schema being stored as a computer-readable document in memory and being an extension of a core SAM schema;
receiving one or more business functionalities, at least one business functionality comprising a plurality of status vectors along a core trace that can be achieved in the core SAM schema, the one or more business functionalities being provided in a computer-readable document stored in memory; and
processing the extended SAM schema and the one or more business functionalities using a computer-executable model checking tool for evaluating a validity of the extended SAM schema.
